(19) United States
(12) Patent Application Publication
(10) Pub. No.: US 2026/0048788 A1
(43) Pub. Date: Feb. 19, 2026

(54) STEERING ANGLE CONTROL FOR STEERED AXLES OF A VEHICLE

(71) Applicant: VOLVO TRUCK CORPORATION, Göteborg (SE)

(72) Inventors: Jonas Persson, Göteborg (SE); Leo Laine, Göteborg (SE); Sidhant Ray, Mölndal (SE)

(73) Assignee: VOLVO TRUCK CORPORATION, Göteborg (SE)

(21) Appl. No.: 19/297,454

(22) Filed: Aug. 12, 2025

(30) Foreign Application Priority Data
Aug. 15, 2024 (EP) 24194785.2

(51) Int. Cl. B62D 7/15

(52) U.S. Cl. CPC B62D 7/159

(57) ABSTRACT

A computer system and computer-implemented method for determining a steering angle for a steered axle of a vehicle having two steered axles are disclosed. The computer system has processing circuitry to acquire a desired yaw angle of the vehicle at a second location; determine a desired yaw rate for the vehicle based on the desired yaw angle and a time for the vehicle to travel from a first location to the second location; acquire a lateral distance between the first location and the second location; determine a desired lateral velocity for the vehicle based on the lateral distance and the time for the vehicle to travel from the first location to the second location; and determine a steering angle for a steered axle of the vehicle using a bicycle model and based on the determined yaw rate and the determined lateral velocity.

### TECHNICAL FIELD

The disclosure relates generally to vehicle control. In particular aspects, the disclosure relates to steering angle control for steered axles of a vehicle. The disclosure can be applied to heavy-duty vehicles, such as trucks, and buses, among other vehicle types. The disclosure can be applied in construction equipment and vehicles, such as excavators, loaders, articulated haulers. Although the disclosure may be described with respect to a particular vehicle, the disclosure is not restricted to any particular vehicle.

### BACKGROUND

When controlling motion of vehicles with multiple steered axles, the steering and propulsion between axles must be coordinated to ensure safe and correct manoeuvring of the vehicle. Current approaches to multi-axle steering are often quite rudimentary, involving simple counter-steering of one axle relative to the other. For example, a rear steered axle may be provided with a steering angle that is proportional but opposite to that of a front steered axle. In other approaches, a rear steered axle may only be used for translational lateral movement, rather than used in a comprehensive steering strategy for diverse driving scenarios.

These approaches can lead to instability at high speeds or on lower friction surfaces. This is particularly relevant when operating construction vehicles such as excavators, loaders, articulated haulers and the like in such scenarios. Operation of such vehicles may therefore be unsafe when employing approaches known in the art, for example when cornering at high speed (relative for construction equipment, around 30 km/h) and/or in low friction scenarios. The freedom of movement of the vehicle is therefore limited.

It is therefore desired to develop a solution for vehicle motion management that addresses or at least mitigates some of these issues.

### SUMMARY

This disclosure provides systems, methods and other approaches for determining a steering angle for a steered axle of a vehicle having two steered axles. In particular, a desired yaw angle of the vehicle between a first location and a second location is acquired. Based on this, a desired yaw rate for the vehicle is determined. A desired lateral distance movement of the vehicle between the first location and the second location is acquired. Based on this, a desired lateral velocity for the vehicle is determined. Based on the determined yaw rate and the determined lateral velocity, a steering angle for the steered axle is determined using a bicycle model. The determined steering angle(s) can then be used in motion control of the vehicle. Setting a steering angle in this way enables increased freedom of movement of the vehicle, as yaw rate and lateral movement are disconnected. This is particularly advantageous at relatively high speeds (e.g. 30 km/h for construction equipment, but typically different based on vehicle types) and offers an improved control strategy for autonomously controlled vehicles, but also offers benefits relating to non- or semi-autonomously controlled vehicles.

According to a first aspect of the disclosure, there is provided a computer system for determining a steering angle for a steered axle of a vehicle having two steered axles, the computer system comprising processing circuitry configured to: acquire a desired yaw angle δf the vehicle at a second location; determine a desired yaw rate ω_{z,req} for the vehicle based on the desired yaw angle and a time for the vehicle to travel from a first location to the second location; acquire a lateral distance between the first location and the second location; determine a desired lateral velocity v_{y,req} for the vehicle based on the lateral distance and the time for the vehicle to travel from the first location to the second location; and determine a steering angle for a steered axle of the vehicle using a bicycle model and based on the desired yaw rate ω_{z,req} and the desired lateral velocity v_{y,req}.

The first aspect of the disclosure may seek to enable increased freedom of movement of the vehicle, as yaw rate and lateral movement of the vehicle are disconnected when setting steering angles. This is particularly advantageous at high speeds and offers an improved control strategy for autonomously controlled vehicles, but also offers benefits relating to non- or semi-autonomously controlled vehicles. The disclosed approach offers several different ways of determining the steering angles, which can be selected based on the circumstances at hand, for example available computational resources and/or a current control mode of the vehicle.

Optionally in some examples, including in at least one preferred example, the steered axle is a front steered axle δr a rear steered axle of the vehicle. A technical benefit may include that a vehicle having two steered axles may be controlled in an improved manner via either of its steered axles.

Optionally in some examples, including in at least one preferred example, the processing circuitry is configured to determine the desired yaw rate ω_{z,req} and/or the desired lateral velocity v_{y,req} based on steady state movement of the vehicle. A technical benefit may include that the vehicle may be controlled to operate in a stable, safe, and efficient manner.

Optionally in some examples, including in at least one preferred example, the processing circuitry is configured to: acquire a current yaw rate ω_{z} of the vehicle and a current lateral velocity v_{y} of the vehicle; and determine a steering angle δ_{f} for a front steered axle and a steering angle δᵣ for a rear steered axle to minimise a difference between the current yaw rate ω_{z} and the desired yaw rate ω_{z,req} and a difference between the current lateral velocity v_{y} and the desired lateral velocity v_{y,req}. A technical benefit may include that steering angles for both steered axles of the vehicle can be determined accurately and with self-correction, with improved performance.

Optionally in some examples, including in at least one preferred example, the processing circuitry is configured to determine the steering angles δ_{f}, δᵣ using optimal control. A technical benefit may include flexibility, computational efficiency, and performance benefits associated with optional control.

Optionally in some examples, including in at least one preferred example, the processing circuitry is configured to: acquire a steering angle for a first steered axle of the vehicle; and determine a steering angle for the other steered axle of the vehicle according to:

$${δ}_{r} = \frac{m}{{C}_{r α}} ( \frac{{v}_{y , req} {c}_{1}}{{v}_{x}} + {ω}_{z , req} ( {v}_{x} + \frac{{c}_{2}}{{v}_{x}} ) - {δ}_{f} \frac{{C}_{f α}}{m} ) \qquad ( a )$$

$$and / or$$

$${δ}_{r} = \frac{{I}_{z}}{{L}_{r} {C}_{r α}} ( - \frac{{v}_{y , req} {c}_{3}}{{v}_{x}} - {ω}_{z , req} \frac{{c}_{4}}{{v}_{x}} + {δ}_{f} \frac{{L}_{f} {C}_{f α}}{{I}_{z}} ) \qquad ( b )$$

where δ_{f} is the steering angle for the front steered axle δᵣ is the steering angle for the rear steered axle, m is the mass of the vehicle, vₓ is the longitudinal velocity of the vehicle, C_{fα} is the cornering stiffness of the front steered axle, C_{rα} is the cornering stiffness of the rear steered axle, L_{f} is the distance from the centre of gravity (CoG) of the vehicle to the front steered axle, Lᵣ is the distance from the CoG of the vehicle to the rear steered axle, I_{z} is the yaw inertia of the vehicle, and c₁ to c₄ represent vehicle constants. A technical benefit may include that a steering angle for a second steered axle of the vehicle can be set based on a steering angle of a first steered axle of the vehicle, which enables simple implementation in existing vehicle motion control systems. This avoids any need for reconfiguration or replacement of existing motion control systems.

Optionally in some examples, including in at least one preferred example, the processing circuitry is configured to determine a first steering angle for the other steered axle according to equation (a), determine a second steering angle for the other steered axle according to equation (b), and determine a resultant steering angle δᵣ for the other steered axle based on a weighted combination of the first steering angle and the second steering angle. A technical benefit may include that a balance can be provided when taking into account the lateral velocity and yaw rate of the vehicle.

Optionally in some examples, including in at least one preferred example, the processing circuitry is configured to acquire the steering angle for the first steered axle of the vehicle from an autonomous driving system of the vehicle. A technical benefit may include that a steering angle for a second steered axle of the vehicle can be determined based on an autonomously set steering angle of a first steered axle of the vehicle, enabling full autonomous control of the steering angles of vehicle.

Optionally in some examples, including in at least one preferred example, the processing circuitry is configured to determine a steering angle δ_{f} for a front steered axle and a steering angle δᵣ for a rear steered axle, according to:

$${δ}_{r} = \frac{m}{{C}_{r α}} ( \frac{{v}_{y , req} {c}_{1}}{{v}_{x}} + {ω}_{z , req} ( {v}_{x} + \frac{{c}_{2}}{{v}_{x}} ) - {δ}_{f} \frac{{C}_{f α}}{m} )$$

$${δ}_{r} = \frac{{I}_{z}}{{L}_{r} {C}_{r α}} ( - \frac{{v}_{y , req} {c}_{3}}{{v}_{x}} - {ω}_{z , req} \frac{{c}_{4}}{{v}_{x}} + {δ}_{f} \frac{{L}_{f} {C}_{f α}}{{I}_{z}} )$$

where m is the mass of the vehicle, vₓ is the longitudinal velocity of the vehicle, C_{fα} is the cornering stiffness of the front steered axle, C_{rα} is the cornering stiffness of the rear steered axle, L_{f} is the distance from the centre of gravity (CoG) of the vehicle to the front steered axle, Lᵣ is the distance from the CoG of the vehicle to the rear steered axle, I_{z} is the yaw inertia of the vehicle, and c₁ to c₄ represent vehicle constants. A technical benefit may include that steering angles can be determined without the need for feedback control, enabling offline testing of the solution, predictable performance, and increased safety.

Optionally in some examples, including in at least one preferred example, the processing circuitry is configured to determine the steering angles δ_{f}, δᵣ offline using a feedforward controller. A technical benefit may include disturbance compensation and response time benefits associated with feedforward control,

Optionally in some examples, including in at least one preferred example, the processing circuitry is configured to transmit the determined steering angle to a controller of the vehicle configured to control the steering angle of the steered axle. A technical benefit may include that the vehicle may be controlled using existing control interfaces to provide increased freedom of movement.

According to a second aspect of the disclosure, there is provided a vehicle comprising the computer system of the first aspect. The second aspect of the disclosure may seek to provide a vehicle capable having increased freedom of movement, as yaw rate and lateral movement of the vehicle are disconnected when setting steering angles. This is particularly advantageous at high speeds and offers an improved control strategy for autonomously controlled vehicles.

According to a third aspect of the disclosure, there is provided a computer-implemented method for determining a steering angle for a steered axle of a vehicle having two steered axles, the computer-implemented method comprising: acquiring, by processing circuitry of a computer system, a desired yaw angle of the vehicle at a second location; determining, by the processing circuitry, a desired yaw rate ω_{z,req} for the vehicle based on the desired yaw angle and a time for the vehicle to travel from a first location to the second location; acquiring, by the processing circuitry, a lateral distance between the first location and the second location; determining, by the processing circuitry, a desired lateral velocity v_{y,req} for the vehicle based on the lateral distance and the time for the vehicle to travel from the first location to the second location; and determining, by the processing circuitry, a steering angle for a steered axle of the vehicle using a bicycle model and based on the desired yaw rate ω_{z,req} and the desired lateral velocity v_{y,req}.

The third aspect of the disclosure may seek to enable increased freedom of movement of the vehicle, as yaw rate and lateral movement of the vehicle are disconnected when setting steering angles. This is particularly advantageous at high speeds and offers an improved control strategy for autonomously controlled vehicles, but also offers benefits relating to non- or semi-autonomously controlled vehicles. The disclosed approach offers several different ways of determining the steering angles, which can be selected based on the circumstances at hand, for example available computational resources and/or a current control mode of the vehicle.

According to a fourth aspect of the disclosure, there is provided a computer program product comprising program code for performing, when executed by processing circuitry, the computer-implemented method of the third aspect. The fourth aspect of the disclosure may seek to enable new vehicles and/or legacy vehicles to be conveniently configured, by software installation/update, to have increased freedom of movement, as yaw rate and lateral movement of the vehicle are disconnected when setting steering angles. This is particularly advantageous at high speeds and offers an improved control strategy for autonomously controlled vehicles, but also offers benefits relating to non- or semi-autonomously controlled vehicles.

According to a fifth aspect of the disclosure, there is provided a non-transitory computer-readable storage medium comprising instructions, which when executed by processing circuitry, cause the processing circuitry to perform the computer-implemented method of the third aspect. The fifth aspect of the disclosure may seek to enable new vehicles and/or legacy vehicles to be conveniently configured, by software installation/update, to have increased freedom of movement, as yaw rate and lateral movement of the vehicle are disconnected when setting steering angles. This is particularly advantageous at high speeds and offers an improved control strategy for autonomously controlled vehicles, but also offers benefits relating to non- or semi-autonomously controlled vehicles.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 schematically shows a vehicle having two steered axles according to an example.

FIG. 2A illustrates a path between two locations for a vehicle according to an example.

FIG. 2B illustrates a path between two locations for a vehicle according to another example.

FIG. 3 is a flow chart of a computer-implemented method according to an example.

FIG. 4 is a schematic diagram of a computer system for implementing examples disclosed herein.

Like reference numerals refer to like elements throughout the description.

### DETAILED DESCRIPTION

The detailed description set forth below provides information and examples of the disclosed technology with sufficient detail to enable those skilled in the art to practice the disclosure.

When controlling motion of vehicles with multiple steered axles, the steering between axles must be coordinated to ensure safe and correct manoeuvring of the vehicle. Current approaches to multi-axle steering are often quite rudimentary and can lead to instability at high speeds or on lower friction surfaces. This is particularly relevant when operating construction vehicles such as excavators, loaders, articulated haulers and the like in such scenarios. Operation of such vehicles may therefore be unsafe when employing approaches known in the art, for example when cornering at high speed (relative for construction equipment, around 30 km/h) and/or in low friction scenarios.

To remedy this, systems, methods and other approaches are provided herein for determining a steering angle for a steered axle of a vehicle having two steered axles. In particular, a desired yaw angle of the vehicle at a second location is acquired. Based on this, a desired yaw rate for the vehicle is determined. A desired lateral distance movement of the vehicle between a first location and the second location is acquired. Based on this, a desired lateral velocity for the vehicle is determined. Based on the determined yaw rate and the determined lateral velocity, a steering angle for the steered axle is determined using a bicycle model. The determined steering angle(s) can then be used in motion control of the vehicle. Setting a steering angle in this way enables increased freedom of movement of the vehicle, as yaw rate and lateral movement are disconnected. This is particularly advantageous at high speeds and offers an improved control strategy for autonomously controlled vehicles, but also offers benefits relating to non- or semi-autonomously controlled vehicles.

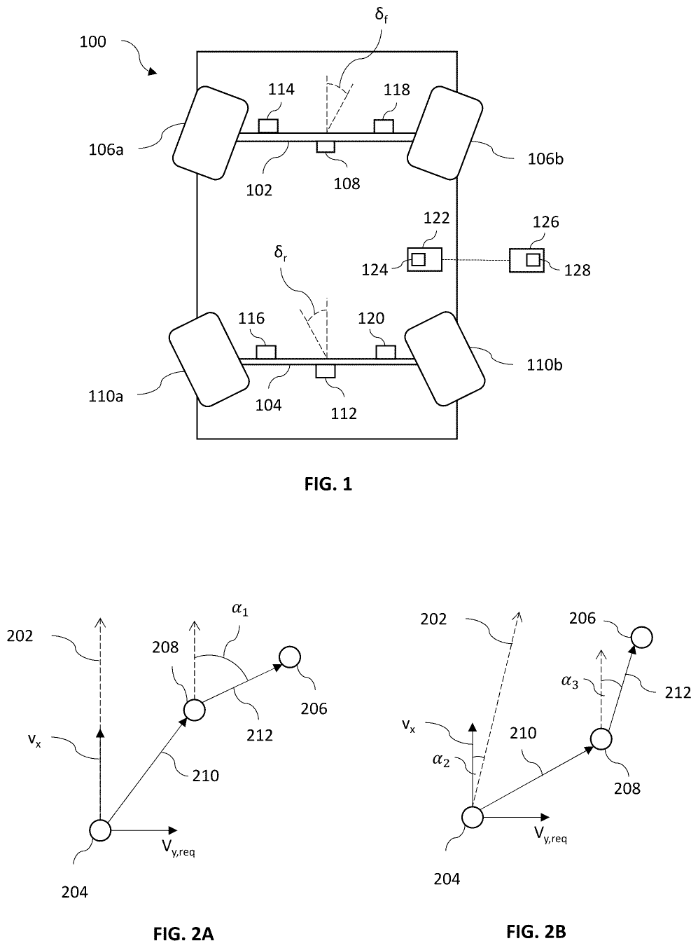

FIG. 1 schematically shows a vehicle 100 having two steered axles 102, 104. The front steered axle 102 has respective left and right wheels 106a, 106b. A steering angle of of the front steered axle 102 and its wheels 106a, 106b is controlled by a front steering actuator 108. The rear steered axle 104 has respective left and right wheels 110a, 110b. A steering angle δr of the rear steered axle 104 and its wheels 110a, 110b is controlled by a rear steering actuator 112. The vehicle 100 may be any suitable vehicle known in the art having two steered axles (each axle including any suitable number of wheels), including heavy-duty vehicles, such as trucks, and buses, among other vehicle types. In some examples, the vehicle 100 may be a construction vehicle, for example any vehicle suitable for transporting bulk material from one location to another. For example, the vehicle 100 may be an excavator, loader, articulated hauler, dump truck, or any other suitable construction vehicle known in the art. Whilst two steered axles 102, 104 are shown, it will be appreciated that further non-steered axles may be provided on the vehicle 100 as appropriate.

The vehicle 100 may also comprise one or more propulsion systems 114, 116 configured to drive, e.g. provide torque and/or steering to, one or more axles 102, 104 or individual wheels 106, 110 of the vehicle 100. The propulsion systems 114, 116 may include one or more electrical machines such as electric motors, which may be able to supply either a positive (propulsion) or negative (braking) force or torque. In the example of FIG. 1, each steered axle 102, 104 has a respective propulsion system 114, 116. As such, the steered axles 102, 104 are both driven axles. It will also be appreciated that any number of the steered axles 102, 104 and/or further axles may be driven axles. For example, in some implementations, only one of the steered axles 102, 104 may be driven. In some examples, a third axle (not shown) may be a driven axle while the steered axles 102, 104 are not driven. In some examples, the individual wheels 106, 110 may have respective propulsion systems. In some examples, the vehicle 100 may also include another source of propulsion, for example an internal combustion engine (ICE). The vehicle 100 also comprises a drivetrain (not shown) to deliver mechanical power from the propulsion source (the electrical machines or the ICE) to the wheels 106, 110.

The vehicle 100 may also comprise one or more brake systems 118, 120, for example one or more sets of service brakes, configured to supply a negative (braking) force. The service brakes may be, for example, frictional brakes such as pneumatic brakes. The steering actuators 108, 112, propulsion systems 114, 116, and brake systems 118, 120 may be collectively referred to as motions support devices (MSDs) of the vehicle 100.

In some examples, the vehicle 100 may be controlled (driven) by an on-board operator (driver). For example, the operator may provide an input to a steering wheel and/or accelerator/brake pedal of the vehicle 100 related to a manoeuvre, for example indicating a desired change of direction and/or speed of the vehicle 100. In other examples, the vehicle 100 may be an autonomous vehicle that is controlled by a vehicle motion management (VMM) unit 122 comprising processing circuitry 124 configured to control motion of the vehicle 100 via the MSDs of the vehicle 100. In some examples, the vehicle 100 may be capable of being controlled by an on-board or remote operator and/or the VMM unit 122, in what may be termed a semi-autonomous driving scenario.

The VMM unit 122 may be configured to provide control signals to each of the MSDs of the vehicle 100. To this end, the VMM unit 122 may be communicatively coupled to the steering actuators 108, 112, propulsion systems 114, 116, and/or brake systems 118, 120. In some examples, the VMM unit 122 may be configured to provide a force, torque, and or longitudinal slip request to the propulsion systems 114, 116 and/or brake systems 118, 120, and/or a steering angle request to each of the steering actuators 108, 112. In a common driving scenario, a steering angle request may involve simple counter-steering of the steered axles 102, 104, where a requested steering angle for the rear steered axle 104 is proportional (for example equal) but opposite to that of the front steered axle 102. FIG. 1 shows a single VMM unit 122 for all MSDs of the vehicle 100, however it will be appreciated that each MSD may comprise a dedicated controller. The VMM unit 122 may be a microcontroller.

In some examples, the VMM unit 122 may determine the control signals itself, for example based on a predetermined mission plan or based on an input from an on-board operator. In some examples, the VMM unit 122 may receive control signals from a computer system 126 comprising processing circuitry 128. The computer system 126 is communicatively coupled to the VMM unit 122. The computer system 126 may be a vehicle control unit configured to perform various vehicle control functions, such as vehicle motion management. The computer system 126 may be local to the vehicle 100, or may be a remote system, implemented at a distance from the vehicle 100, e.g. a cloud server for remote control of the vehicle 100.

A communicative coupling as referred to above may be implemented in any suitable way, for example via a circuit or any other wired, wireless, or network connection known in the art. Furthermore, a communicative coupling may be implemented as a direct connection, e.g. between the VMM unit 122 and the computer system 126, or as a connection via one or more intermediate entities.

One function of the VMM unit 122 and the computer system 126 is to provide control inputs for the MSDs of the vehicle 100 to enable motion of the vehicle 100, for example including straight-line driving, cornering, braking and the like. The implemented motion should be safe, stable, and enable sufficient freedom of movement of the vehicle 100. To this end, a number of principles of motion for the vehicle 100 can be considered.

When a vehicle is travelling from one location to another including some lateral movement, there are two factors that are important: yaw rate and lateral velocity. The yaw rate is the angular velocity of lateral rotation of the vehicle, while the lateral velocity is the velocity at which the vehicle travels in the lateral direction. A yaw angle of the vehicle may also be important. For example, in a longer curve (e.g. 90°), it may be acceptable or even desired for the vehicle to have a certain yaw angle. In a lane change, for example on a high speed road, it may be desired that the yaw angle remains substantially constant, e.g. close to zero. FIGS. 2A and 2B illustrate examples of a path for a vehicle, such as the vehicle 100, from one location to another. The path may contain a number of locations the vehicle is intended to pass through.

FIG. 2A is an example of a vehicle travelling a longer curve. In the example of FIG. 2A, a vehicle facing and travelling in a direction 202 and having a longitudinal velocity vₓ may travel from a first location 204 to a second location 206 via an intermediate location 208. A first path 210 is defined between the first location 204 and the intermediate location 208. A second path 212 defined between the intermediate location 208 and the second location 206. It is desired for the vehicle to have a yaw angle α₁ when it reaches the second location 206. To travel from the first location 204 to the location 206, the vehicle requires a lateral velocity v_{y,req}.

FIG. 2B is an example of a vehicle making a lane change. In this example, a vehicle is facing and travelling in a direction 202, and has an initial yaw angle α₂ and a longitudinal velocity vₓ. The vehicle may travel from a first location 204 to a second location 206 via an intermediate location 208. A first path 210 is defined between the first location 204 and the intermediate location 208. A second path 212 defined between the intermediate location 208 and the second location 206. It is desired for the vehicle to have a yaw angle α₃ when it reaches the second location 206. To travel from the first location 204 to the second location 206, the vehicle requires a lateral velocity v_{y,req}.

For a vehicle having two steered axles, such as the vehicle 100, yaw rate and lateral velocity can be decoupled in a way that is not possible for vehicles having a single steered axle. A relation between yaw rate ω_{z}, yaw acceleration \dot{ω}_{z}, lateral velocity v_{y}, lateral acceleration \dot{v}_{y}, longitudinal velocity vₓ, and the steering angles δ_{f}, δᵣ for such a vehicle can be described using a bicycle model, for example as follows:

$$[ \begin{matrix}{\dot{v}}_{y} \\ {\dot{ω}}_{z}\end{matrix} ] = A [ \begin{matrix}{v}_{y} \\ {ω}_{z}\end{matrix} ] + B [ \begin{matrix}{δ}_{f} \\ {δ}_{r}\end{matrix} ] \qquad ( 1 )$$

$$A = - [ \begin{matrix}\frac{{C}_{f α} + {C}_{r α}}{{mv}_{x}} & {v}_{x} + \frac{{L}_{f} {C}_{f α} - {L}_{r} {C}_{r α}}{{mv}_{x}} \\ \frac{{L}_{f} {C}_{f α} - {L}_{r} {C}_{r α}}{{I}_{z} {v}_{x}} & \frac{{{L}_{f}}^{2} {C}_{f α} - {{L}_{r}}^{2} {C}_{r α}}{{I}_{z} {v}_{x}}\end{matrix} ]$$

$$B = [ \begin{matrix}\frac{{C}_{f α}}{m} & \frac{{C}_{r α}}{m} \\ \frac{{L}_{f} {C}_{f α}}{{I}_{z}} & - \frac{{L}_{r} {C}_{r α}}{{I}_{z}}\end{matrix} ]$$

where C_{fα} is the cornering stiffness of the front steered axle 102, C_{rα} is the cornering stiffness of the rear steered axle 104, m is the mass of the vehicle 100, L_{f} is the distance from the centre of gravity (CoG) of the vehicle 100 to the front steered axle 102, Lᵣ is the distance from the CoG of the vehicle 100 to the rear steered axle 104, and I_{z} is the yaw inertia of the vehicle 100. The cornering stiffnesses C_{fα}, C_{rα} may be determined from tyre properties of the vehicle 100. The longitudinal velocity vₓ of the vehicle 100 may be a current value determined in any suitable manner known in the art, for example using speed sensors of the vehicle 100, or a desired value.

By using this relation and knowledge of the locations along a path the vehicle is intended to pass through, it is possible to calculate the required yaw rate ω_{z,req} and lateral velocity v_{y,req} of the vehicle. Taking the examples of FIGS. 2A and 2B, given a certain longitudinal velocity vₓ and knowledge of the longitudinal distance between the first location 204 and the second location 206, the time t taken to travel longitudinally from the first location 204 to the second location 206 can be determined. Based on this, and given a steady state in which \dot{ω}_{z}=0 and \dot{v}_{y}=0, the required yaw rate ω_{z,req} and lateral velocity v_{y,req} of the vehicle 100 can be determined as follows:

$${ω}_{z , req} = \frac{Δα}{t} \qquad ( 2 )$$

$${v}_{y , req} = \frac{Δ y}{t} \qquad ( 3 )$$

where Δα is the required change in yaw angle α (i.e. α₁ in FIG. 2A and α₃-α₂ in FIG. 2B) and Δy is the lateral distance between the first location 204 and the second location 206. It is noted that the steady state assumption mentioned above is particularly useful in certain scenarios, for example a lane change. However, the time t taken to travel longitudinally from the first location 204 to the second location 206 can be determined in any suitable way, for example using an estimated, expected, or desired time.

This can then be used to calculate the required steering angles δ_{f}, δᵣ using the relation in equation (1) based on desired values of yaw acceleration \dot{ω}_{z} and lateral acceleration \dot{v}_{y}. Given a steady state, where \dot{ω}_{z}=0 and \dot{v}_{y}=0, this can be expressed as follows:

$$[ \begin{matrix}\frac{{v}_{y , req} {c}_{1}}{{v}_{x}} & {ω}_{z , req} ( {v}_{x} + \frac{{c}_{2}}{{v}_{x}} ) \\ \frac{{v}_{y , req} {c}_{3}}{{v}_{x}} & {ω}_{z , req} \frac{{c}_{4}}{{v}_{x}}\end{matrix} ] = B [ \begin{matrix}{δ}_{f} \\ {δ}_{r}\end{matrix} ] \qquad ( 4 )$$

$${c}_{1} = \frac{{C}_{af} + {C}_{ar}}{m}$$

$${c}_{2} = \frac{{L}_{f} {C}_{af} - {L}_{r} {C}_{ar}}{m}$$

$${c}_{3} = \frac{{L}_{f} {C}_{af} - {L}_{r} {C}_{ar}}{{I}_{z}}$$

$${c}_{4} = \frac{{L}_{f}^{2} {C}_{af} - {L}_{r}^{2} {C}_{ar}}{{I}_{z}}$$

where c₁ to C₄ represent vehicle constants and can be measured or calculated as appropriate.

This yields an equation system with two unknowns, the required steering angles δ_{f}, δᵣ, as follows:

$$\frac{{v}_{y , req} {c}_{1}}{{v}_{x}} + {ω}_{z , req} ( {v}_{x} + \frac{{c}_{2}}{{v}_{x}} ) = {δ}_{f} \frac{{C}_{f α}}{m} + {δ}_{r} \frac{{C}_{r α}}{m} \qquad ( 5 )$$

$$\frac{{v}_{y , req} {c}_{3}}{{v}_{x}} + {ω}_{z , req} \frac{{c}_{4}}{{v}_{x}} = {δ}_{f} \frac{{L}_{f} {C}_{f α}}{{I}_{z}} - {δ}_{r} \frac{{L}_{r} {C}_{r α}}{{I}_{z}} \qquad ( 6 )$$

An example relation can then be set as follows:

$${δ}_{r} = \frac{m}{{C}_{r α}} ( \frac{{v}_{y , req} {c}_{1}}{{v}_{x}} + {ω}_{z , req} ( {v}_{x} + \frac{{c}_{2}}{{v}_{x}} ) - {δ}_{f} \frac{{C}_{f α}}{m} ) \qquad ( 7 )$$

$${δ}_{r} = \frac{{I}_{z}}{{L}_{r} {C}_{r α}} ( - \frac{{v}_{y , req} {c}_{3}}{{v}_{x}} - {ω}_{z , req} \frac{{c}_{4}}{{v}_{x}} + {δ}_{f} \frac{{L}_{f} {C}_{f α}}{{I}_{z}} ) \qquad ( 8 )$$

In this case, the steering angle δᵣ of the rear steered axle 104 can be set based on the steering angle δ_{f} of the front steered axle 102, or vice versa.

The system of equations outlined above can be used in three different ways to determine the steering angles δ_{f}, δᵣ for the steered axles 102, 104.
1. Solving equations (7) and (8) to determine the steering angles δ_{f}, δᵣ offline, for example using a feedforward controller.
2. Using a path-following controller based on equation (1), using the required yaw rate ω_{z,req} and lateral velocity v_{y,req} of the vehicle 100 as reference targets, to determine the steering angles δ_{f}, δᵣ online.
3. Receiving the steering angle for a first steered axle online, for example from an autonomous driving system, and determining the steering angle for the other steered axle based on equation (7) and/or (8).

In the first approach, the steering angles δ_{f}, δᵣ can be determined by solving equations (7) and (8). This can be achieved, for example, using a feedforward controller. A feedforward controller is a type of control system that uses a model to predict a control action needed to achieve a desired output. Feedforward controllers anticipate changes and act pre-emptively to correct disturbances.

In the second approach, a path-following controller is used to determine the steering angles δ_{f}, δᵣ. A path-following controller is a type of control system designed to ensure that a vehicle a predefined path accurately. The main goal of a path-following controller is to minimize the deviation between the actual path and the desired path. In this approach, the “path” is set by the requested yaw rate ω_{z,req} and lateral velocity v_{y,req}, and the controller attempts to ensure the vehicle 100 meets these values as closely as possible through a linear quadratic regulator or similar. The controller may be an optimal controller such as a model predictive controller (MPC) or a linear-quadratic-Gaussian (LQR) controller as known in the art.

The controller may acquire a current yaw rate ω_{z} and lateral velocity v_{y}. These may be determined in any suitable manner known in the art, for example using appropriate sensors of the vehicle 100. The current value(s) ω_{z}, v_{y} may then be compared to the respective required value(s) ω_{z,req}, v_{y,req}, to determine a difference between them. A cost function can be formulated as follows:

$$\dot{x} = Ax + Bu \qquad ( 9 )$$

$$x = [ \begin{matrix}{ω}_{z} - {ω}_{z , req} & {v}_{y} - {v}_{y , req}\end{matrix} ]$$

$$u = [ \begin{matrix}{δ}_{f} & {δ}_{r}\end{matrix} ]$$

where A and B are as defined in equation (1). This cost function can be solved by the controller to provide a gain matrix K, where:

$$u = - Kx \qquad ( 9 )$$

As the system is linear, the optimal control action u can be calculated by minimising the control input and the error between the desired states and the current states of the vehicle. The output u then describes the steering angles δ_{f}, δᵣ. This approach can be performed online, and provides correction in the case of any parameter errors as well as a more dynamic controller.

In the third approach, a steering angle for a first axle is acquired from some input and a steering angle for the other axle is determined using equation (7) and/or (8). For example, a steering angle δ_{f}, for the front steered axle 102 may be acquired, for example received from an operator input to a steering wheel or an automated driving system such as the VMM unit 122 or computer system 126. This may be inserted into equation (7) and/or (8) to provide the steering angle δᵣ for the rear steered axle 104. This can be performed in a manner such that the steering angle δᵣ for the rear steered axle 104 is implemented at some time in the future (e.g. a few seconds) based on the longitudinal velocity. This approach can be used offline, whereby a lookup table of values for the various parameters can be constructed and used to determine an appropriate steering angle δᵣ for the rear steered axle 104 in a given situation. This allows the steering angle δ_{f} for the front steered axle 102 to be controlled with feedback through an autonomous driving system such as the VMM unit 122 or the computer system 126, while the intended vehicle movement is supported by the steering angle δᵣ for the rear steered axle 104. When less yaw moment is required, which is normally the case at higher speeds, this approach allows the rear steered axle 104 to either counter-steer less or steer parallel to the front steered axle 102, increasing stability. Alternatively, the steering angle δᵣ for the rear steered axle 104 may be acquired, for example received from an operator input to a steering wheel or an automated driving system, and inserted into equation (7) and/or (8) to provide a steering angle δ_{f}, for the front steered axle 102 in a similar fashion.

Equation (7) is based primarily on the lateral velocity, while equation (8) is based primarily on the yaw rate. These equations may provide different results for the steering angle δᵣ for the rear steered axle 104. Therefore, it may be desired to balance between the two equations. This can be achieved, for example, using an iterative weighting process where the solution for each equation is weighted to provide an intermediate value. In some examples, the solution for equation (7) may be weighted more heavily than the solution for equation (8) due to the importance of the lateral velocity.

Setting steering angles in this way enables increased freedom of movement of the vehicle, as yaw rate and lateral movement of the vehicle are disconnected. This is particularly advantageous at high speeds and offers an improved control strategy for autonomously controlled vehicles. The disclosed approach offers several different ways of determining the steering angles, which can be selected based on the circumstances at hand, for example available computational resources and/or a current control mode of the vehicle.

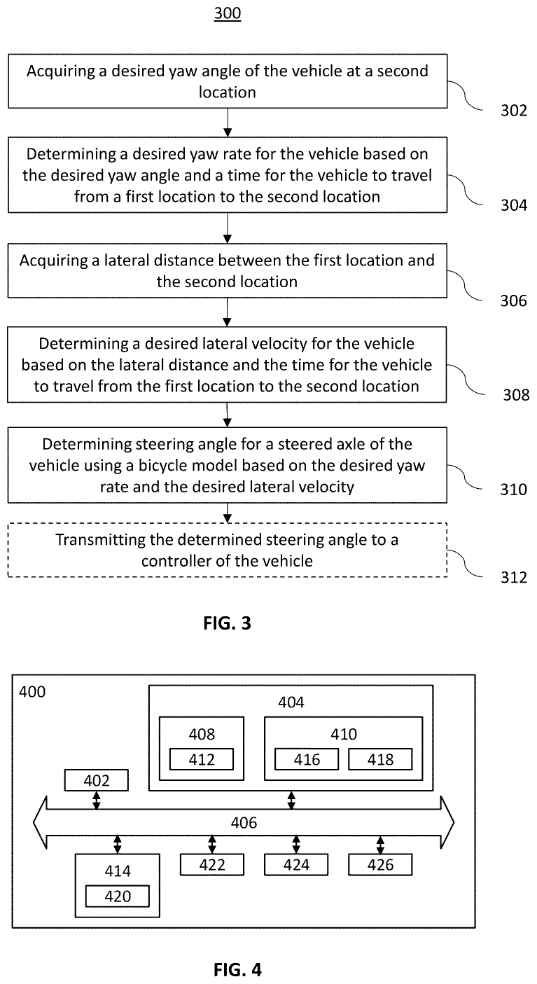

FIG. 3 is a flow chart of a computer-implemented method 300 according to an example. The method 300 is for determining a steering angle for a steered axle of a vehicle having two steered axles, such as the vehicle 100. The method 300 enables increased freedom of movement of the vehicle, as yaw rate and lateral movement are disconnected. This is particularly advantageous at high speeds and offers an improved control strategy for autonomously controlled vehicles. The method 300 may be implemented by processing circuitry of a computer system (e.g., the processing circuitry 124 of the VMM unit 122, or the processing circuitry 128 of the computer system 126 described in relation to FIG. 1).

At 302, a desired yaw angle α of the vehicle 100 at a second (e.g. future) location is acquired. This may be acquired based on a known route or path for the vehicle 100, or may be determined online based on an updated route or path. The desired yaw angle α may be used to determine a required change in yaw angle Δα based on the current heading of the vehicle 100, for example by comparing the desired yaw angle α to a current yaw angle of the vehicle 100.

At 304, a desired yaw rate ω_{z,req} for the vehicle 100 is determined based on the desired yaw angle α acquired at 302 and a time t for the vehicle 100 to travel from a first (e.g. current) location to the second location. The time t can be determined, for example, based on a current or desired longitudinal velocity vₓ for the vehicle 100 and the longitudinal distance between the first and second locations, or using an estimated, expected, or desired time. Given a steady state in which \dot{ω}_{z=}0, the desired yaw rate ω_{z,req} can be determined based on equation (2).

At 306, a lateral distance between the first location and the second location is acquired. This may be acquired based on a known route or path for the vehicle 100, or may be determined online based on an updated route or path.

At 308, a desired lateral velocity v_{y,req} for the vehicle 100 is determined based on the lateral distance acquired at 306 and the time t. Given a steady state in which \dot{v}_{y}=0, the desired lateral velocity v_{y,req} can be determined based on equation (3).

At 310, a steering angle δ_{f}, δᵣ or for a steered axle 102, 104 of the vehicle 100 is determined using a bicycle model based on the desired yaw rate ω_{z,req} determined at 306 and the desired lateral velocity v_{y,req} determined at 308. As discussed above, this may be determined in one of three ways:
1. Solving equations (7) and (8) to determine the steering angles of, or offline, for example using a feedforward controller.
2. Using a path-following controller based on equation (1), using the required yaw rate ω_{z,req} and lateral velocity v_{y,req} of the vehicle 100 as reference targets, to determine the steering angles of, or online.
3. Receiving a steering angle for a first axle (e.g. the steering angle of for the front steered axle 102) online, for example from an autonomous driving system, and determining the steering angle for the other axle (e.g. the steering angle δᵣ for the rear steered axle 104) based on equation (7) and/or (8).

At 312, the determined steering angle(s) δ_{f}, δᵣ may be transmitted to a controller of the vehicle 100 configured to control one or more motion parameters of the steered axle(s) 102, 104. For example, if the method 300 is performed at the computer system 126, the determined steering angle(s) of, or may be transmitted to the VMM unit 122. The determined steering angle(s) of, or may then be transmitted to steering actuator 108, 112 of the appropriate steered axle 102, 104. This can be implemented in a simple manner using existing control interfaces of the vehicle 100.

FIG. 4 is a schematic diagram of a computer system 400 for implementing examples disclosed herein. The computer system 400 is adapted to execute instructions from a computer-readable medium to perform these and/or any of the functions or processing described herein. The computer system 400 may be connected (e.g., networked) to other machines in a LAN, an intranet, an extranet, or the Internet. While only a single device is illustrated, the computer system 400 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 400 may comprise at least one computing device or electronic device capable of including firmware, hardware, and/or executing software instructions to implement the functionality described herein. The computer system 400 may include processing circuitry 402 (e.g., processing circuitry including one or more processor devices or control units), a memory 404, and a system bus 406. The computer system 400 may include at least one computing device having the processing circuitry 402. The system bus 406 provides an interface for system components including, but not limited to, the memory 404 and the processing circuitry 402. The processing circuitry 402 may include any number of hardware components for conducting data or signal processing or for executing computer code stored in memory 404. The processing circuitry 402 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 402 may further include computer executable code that controls operation of the programmable device.

The system bus 406 may be any of several types of bus structures that may further interconnect to a memory bus (with or without a memory controller), a peripheral bus, and/or a local bus using any of a variety of bus architectures. The memory 404 may be one or more devices for storing data and/or computer code for completing or facilitating methods described herein. The memory 404 may include database components, object code components, script components, or other types of information structure for supporting the various activities herein. Any distributed or local memory device may be utilized with the systems and methods of this description. The memory 404 may be communicably connected to the processing circuitry 402 (e.g., via a circuit or any other wired, wireless, or network connection) and may include computer code for executing one or more processes described herein. The memory 404 may include non-volatile memory 408 (e.g., read-only memory (ROM), erasable programmable read-only memory (EPROM), electrically erasable programmable read-only memory (EEPROM), etc.), and volatile memory 410 (e.g., random-access memory (RAM)), or any other medium which can be used to carry or store desired program code in the form of machine-executable instructions or data structures and which can be accessed by a computer or other machine with processing circuitry 402. A basic input/output system (BIOS) 412 may be stored in the non-volatile memory 408 and can include the basic routines that help to transfer information between elements within the computer system 400.

The computer system 400 may further include or be coupled to a non-transitory computer-readable storage medium such as the storage device 414, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 414 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 414 and/or in the volatile memory 410, which may include an operating system 416 and/or one or more program modules 418. All or a portion of the examples disclosed herein may be implemented as a computer program 420 stored on a transitory or non-transitory computer-usable or computer-readable storage medium (e.g., single medium or multiple media), such as the storage device 414, which includes complex programming instructions (e.g., complex computer-readable program code) to cause the processing circuitry 402 to carry out actions described herein. Thus, the computer-readable program code of the computer program 420 can comprise software instructions for implementing the functionality of the examples described herein when executed by the processing circuitry 402. In some examples, the storage device 414 may be a computer program product (e.g., readable storage medium) storing the computer program 420 thereon, where at least a portion of a computer program 420 may be loadable (e.g., into a processor) for implementing the functionality of the examples described herein when executed by the processing circuitry 402. The processing circuitry 402 may serve as a controller or control system for the computer system 400 that is to implement the functionality described herein.

The computer system 400 may include an input device interface 422 configured to receive input and selections to be communicated to the computer system 400 when executing instructions, such as from a keyboard, mouse, touch-sensitive surface, etc. Such input devices may be connected to the processing circuitry 402 through the input device interface 422 coupled to the system bus 406 but can be connected through other interfaces, such as a parallel port, an Institute of Electrical and Electronic Engineers (IEEE) 1394 serial port, a Universal Serial Bus (USB) port, an IR interface, and the like. The computer system 400 may include an output device interface 424 configured to forward output, such as to a display, a video display unit (e.g., a liquid crystal display (LCD) or a cathode ray tube (CRT)). The computer system 400 may include a communications interface 426 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:

Example 1: A computer system (122, 126, 400) for determining a steering angle for a steered axle (102, 104) of a vehicle (100) having two steered axles (102, 104), the computer system (122, 126, 400) comprising processing circuitry (124, 128, 402) configured to: acquire a desired yaw angle of the vehicle (100) at a second location (206); determine a desired yaw rate ω_{z,req} for the vehicle (100) based on the desired yaw angle and a time for the vehicle (100) to travel from a first location (204) to the second location (206); acquire a lateral distance between the first location (204) and the second location (206); determine a desired lateral velocity v_{y,req} for the vehicle (100) based on the lateral distance and the time for the vehicle (100) to travel from the first location (204) to the second location (206); and determine a steering angle for a steered axle (102, 104) of the vehicle (100) using a bicycle model and based on the desired yaw rate ω_{z,req} and the desired lateral velocity v_{y,req}.

Example 2: The computer system (122, 126, 400) of example 1, wherein the steered axle (102, 104) is a front steered axle (102) or a rear steered axle (104) of the vehicle (100).

Example 3: The computer system (122, 126, 400) of example 1 or 2, wherein the processing circuitry (124, 128, 402) is configured to determine the desired yaw rate ω_{z,req} and/or the desired lateral velocity v_{y,req} based on steady state movement of the vehicle (100).

Example 4: The computer system (122, 126, 400) of any preceding example, wherein the processing circuitry (124, 128, 402) is configured to: acquire a current yaw rate oz of the vehicle (100) and a current lateral velocity v_{y} of the vehicle (100); and determine a steering angle δ_{f} for a front steered axle (102) and a steering angle δᵣ for a rear steered axle (104) to minimise a difference between the current yaw rate ωz and the desired yaw rate ω_{z,req} and a difference between the current lateral velocity v_{y} and the desired lateral velocity v_{y,req}.

Example 5: The computer system (122, 126, 400) of example 4, wherein the processing circuitry (124, 128, 402) is configured to determine the steering angles δ_{f}, δᵣ using optimal control.

Example 6: The computer system (122, 126, 400) of any of examples 1 to 3, wherein the processing circuitry (124, 128, 402) is configured to: acquire a steering angle for a first steered axle (102, 104) of the vehicle (100); and determine a steering angle for the other steered axle (102, 104) of the vehicle (100) according to:

$${δ}_{r} = \frac{m}{{C}_{r α}} ( \frac{{v}_{y , req} {c}_{1}}{{v}_{x}} + {ω}_{z , req} ( {v}_{x} + \frac{{c}_{2}}{{v}_{x}} ) - {δ}_{f} \frac{{C}_{f α}}{m} ) \qquad ( a )$$

$$and / or$$

$${δ}_{r} = \frac{{I}_{z}}{{L}_{r} {C}_{r α}} ( - \frac{{v}_{y , req} {c}_{3}}{{v}_{x}} - {ω}_{z , req} \frac{{c}_{4}}{{v}_{x}} + {δ}_{f} \frac{{L}_{f} {C}_{f α}}{{I}_{z}} ) \qquad ( b )$$

where δ_{f} is the steering angle for the front steered axle (102) δᵣ is the steering angle for the rear steered axle (104), m is the mass of the vehicle (100), vₓ is the longitudinal velocity of the vehicle (100), C_{fα} is the cornering stiffness of the front steered axle (102), C_{rα} is the cornering stiffness of the rear steered axle (104), L_{f} is the distance from the centre of gravity “CoG” of the vehicle (100) to the front steered axle (102), Lᵣ is the distance from the CoG of the vehicle (100) to the rear steered axle (104), I_{z} is the yaw inertia of the vehicle (100), and c₁ to c₄ represent vehicle constants.

Example 7: The computer system (122, 126, 400) of example 6, wherein the processing circuitry (124, 128, 402) is configured to determine a first steering angle for the other steered axle (102, 104) according to equation (a), acquire a second steering angle for the other steered axle (102, 104) according to equation (b), and determine a resultant steering angle Sr for the other steered axle (102, 104) based on a weighted combination of the first steering angle and the second steering angle.

Example 8: The computer system (122, 126, 400) of example 6 or 7, wherein the processing circuitry (124, 128, 402) is configured to acquire the steering angle for the first steered axle (102, 104) of the vehicle (100) from an autonomous driving system (122, 126) of the vehicle (100).

Example 9: The computer system (122, 126, 400) of any of examples 1 to 3, wherein the processing circuitry (124, 128, 402) is configured to determine a steering angle δ_{f} for a front steered axle (102) and a steering angle δᵣ for a rear steered axle (104), according to:

$${δ}_{r} = \frac{m}{{C}_{r α}} ( \frac{{v}_{y , req} {c}_{1}}{{v}_{x}} + {ω}_{z , req} ( {v}_{x} + \frac{{c}_{2}}{{v}_{x}} ) - {δ}_{f} \frac{{C}_{f α}}{m} )$$

$${δ}_{r} = \frac{{I}_{z}}{{L}_{r} {C}_{r α}} ( - \frac{{v}_{y , req} {c}_{3}}{{v}_{x}} - {ω}_{z , req} \frac{{c}_{4}}{{v}_{x}} + {δ}_{f} \frac{{L}_{f} {C}_{f α}}{{I}_{z}} )$$

where m is the mass of the vehicle (100), vₓ is the longitudinal velocity of the vehicle (100), C_{fα} is the cornering stiffness of the front steered axle (102), C_{rα} is the cornering stiffness of the rear steered axle (104), L_{f} is the distance from the centre of gravity “CoG” of the vehicle (100) to the front steered axle (102), Lᵣ is the distance from the CoG of the vehicle (100) to the rear steered axle (104), I_{z} is the yaw inertia of the vehicle (100), and c₁ to c₄ represent vehicle constants.

Example 10: The computer system (122, 126, 400) of example 9, wherein the processing circuitry (124, 128, 402) is configured to determine the steering angles δ_{f}, δᵣ offline using a feedforward controller.

Example 11: The computer system (122, 126, 400) of any preceding example, wherein the processing circuitry (124, 128, 402) is configured to transmit the determined steering angle to a controller (122, 126) of the vehicle (100) configured to control the steering angle of the steered axle (102, 104).

Example 12: A vehicle (100) comprising the computer system (122, 126, 400) of any preceding example.

Example 13: A computer-implemented method (300) for determining a steering angle for a steered axle (102, 104) of a vehicle (100) having two steered axles (102, 104), the computer-implemented method (300) comprising: acquiring (302), by processing circuitry (124, 128, 402) of a computer system (122, 126, 400), a desired yaw angle of the vehicle (100) at a second location (206); determining (304), by the processing circuitry (124, 128, 402), a desired yaw rate ω_{z,req} for the vehicle (100) based on the desired yaw angle and a time for the vehicle (100) to travel from a first location (204) to the second location (206); acquiring (306), by the processing circuitry (124, 128, 402), a lateral distance between the first location (204) and the second location (206); determining (308), by the processing circuitry (124, 128, 402), a desired lateral velocity v_{y,req} for the vehicle (100) based on the lateral distance and the time for the vehicle (100) to travel from the first location (204) to the second location (206); and determining (310), by the processing circuitry (124, 128, 402), a steering angle for a steered axle (102, 104) of the vehicle (100) using a bicycle model and based on the desired yaw rate ω_{z,req} and the desired lateral velocity v_{y,req}.

Example 14: The computer-implemented method (300) of example 13, wherein the steered axle (102, 104) is a front steered axle (102) or a rear steered axle (104) of the vehicle (100).

Example 15: The computer-implemented method (300) of example 13 or 14, comprising determining, by the processing circuitry (124, 128, 402), the desired yaw rate ω_{z,req} and/or the desired lateral velocity v_{y,req} based on steady state movement of the vehicle (100).

Example 16: The computer-implemented method (300) of any of examples 13 to 15, comprising: acquiring, by the processing circuitry (124, 128, 402), a current yaw rate oz of the vehicle (100) and a current lateral velocity v_{y} of the vehicle (100); and determining (310), by the processing circuitry (124, 128, 402), a steering angle δ_{f} for a front steered axle (102) and a steering angle δᵣ for a rear steered axle (104) to minimise a difference between the current yaw rate ω_{z} and the desired yaw rate ω_{z,req} and a difference between the current lateral velocity v_{y} and the desired lateral velocity v_{y,req}.

Example 17: The computer-implemented method (300) of example 16, comprising determining (310), by the processing circuitry (124, 128, 402), the steering angles δ_{f}, δᵣ using optimal control.

Example 18: The computer-implemented method (300) of any of examples 13 to 15, comprising: acquiring, by the processing circuitry (124, 128, 402), a steering angle for a first steered axle (102, 104) of the vehicle (100); and determining (310), by the processing circuitry (124, 128, 402), a steering angle for the other steered axle (102, 104) of the vehicle (100) according to:

$${δ}_{r} = \frac{m}{{C}_{r α}} ( \frac{{v}_{y , req} {c}_{1}}{{v}_{x}} + {ω}_{z , req} ( {v}_{x} + \frac{{c}_{2}}{{v}_{x}} ) - {δ}_{f} \frac{{C}_{f α}}{m} ) \qquad ( a )$$

$$and / or$$

$${δ}_{r} = \frac{{I}_{z}}{{L}_{r} {C}_{r α}} ( - \frac{{v}_{y , req} {c}_{3}}{{v}_{x}} - {ω}_{z , req} \frac{{c}_{4}}{{v}_{x}} + {δ}_{f} \frac{{L}_{f} {C}_{f α}}{{I}_{z}} ) \qquad ( b )$$

where δ_{f} is the steering angle for the front steered axle (102) δᵣ is the steering angle for the rear steered axle (104), m is the mass of the vehicle (100), vₓ is the longitudinal velocity of the vehicle (100), C_{fα} is the cornering stiffness of the front steered axle (102), C_{rα} is the cornering stiffness of the rear steered axle (104), L_{f} is the distance from the centre of gravity “CoG” of the vehicle (100) to the front steered axle (102), Lᵣ is the distance from the CoG of the vehicle (100) to the rear steered axle (104), I_{z} is the yaw inertia of the vehicle (100), and c₁ to c₄ represent vehicle constants.

Example 19: The computer-implemented method (300) of example 18, comprising determining, by the processing circuitry (124, 128, 402), a first steering angle for the other steered axle (102, 104) according to equation (a), determining, by the processing circuitry (124, 128, 402), a second steering angle for the other steered axle (102, 104) according to equation (b), and determining, by the processing circuitry (124, 128, 402), a resultant steering angle dr for the other steered axle (102, 104) based on a weighted combination of the first steering angle and the second steering angle.

Example 20: The computer-implemented method (300) of example 18 or 19, comprising acquiring, by the processing circuitry (124, 128, 402), the steering angle for the first steered axle (102, 104) of the vehicle (100) from an autonomous driving system (122, 126) of the vehicle (100).

Example 21: The computer-implemented method (300) of any of examples 13 to 15, comprising determining (310), by the processing circuitry (124, 128, 402), a steering angle δ_{f} for a front steered axle (102) and a steering angle δᵣ for a rear steered axle (104), according to:

$${δ}_{r} = \frac{m}{{C}_{r α}} ( \frac{{v}_{y , req} {c}_{1}}{{v}_{x}} + {ω}_{z , req} ( {v}_{x} + \frac{{c}_{2}}{{v}_{x}} ) - {δ}_{f} \frac{{C}_{f α}}{m} )$$

$${δ}_{r} = \frac{{I}_{z}}{{L}_{r} {C}_{r α}} ( - \frac{{v}_{y , req} {c}_{3}}{{v}_{x}} - {ω}_{z , req} \frac{{c}_{4}}{{v}_{x}} + {δ}_{f} \frac{{L}_{f} {C}_{f α}}{{I}_{z}} )$$

where m is the mass of the vehicle (100), vₓ is the longitudinal velocity of the vehicle (100), C_{fα} is the cornering stiffness of the front steered axle (102), C_{rα} is the cornering stiffness of the rear steered axle (104), L_{f} is the distance from the centre of gravity “CoG” of the vehicle (100) to the front steered axle (102), Lᵣ is the distance from the CoG of the vehicle (100) to the rear steered axle (104), I_{z} is the yaw inertia of the vehicle (100), and c₁ to C₄ represent vehicle constants.

Example 22: The computer-implemented method (300) of example 21, comprising determining (310), by the processing circuitry (124, 128, 402), the steering angles δ_{f}, δᵣ offline using a feedforward controller.

Example 23: The computer-implemented method (300) of any of examples 13 to 22, comprising transmitting (312) the determined steering angle to a controller (122, 126) of the vehicle (100) configured to control the steering angle of the steered axle (102, 104).

Example 24: A computer program product comprising program code for performing, when executed by processing circuitry (124, 128, 402), the computer-implemented method (300) of any of examples 13 to 23.

Example 25: A non-transitory computer-readable storage medium comprising instructions, which when executed by processing circuitry (124, 128, 402), cause the processing circuitry to perform the computer-implemented method (300) of any of examples 13 to 23.

Terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system for determining a steering angle for a steered axle of a vehicle having two steered axles, the computer system comprising processing circuitry configured to:
acquire a desired yaw angle of the vehicle at a second location;
determine a desired yaw rate ω_{z,req} for the vehicle based on the desired yaw angle and a time for the vehicle to travel from a first location to the second location;
acquire a lateral distance between the first location and the second location;
determine a desired lateral velocity v_{y,req} for the vehicle based on the lateral distance and the time for the vehicle to travel from the first location to the second location; and
determine a steering angle for a steered axle of the vehicle using a bicycle model and based on the desired yaw rate ω_{z,req} and the desired lateral velocity v_{y,req}.

2. The computer system of claim 1, wherein the steered axle is a front steered axle δr a rear steered axle of the vehicle.

3. The computer system of claim 1, wherein the processing circuitry is configured to determine the desired yaw rate ω_{z,req} and/or the desired lateral velocity v_{y,req} based on steady state movement of the vehicle.

4. The computer system of claim 1, wherein the processing circuitry is configured to:
acquire a current yaw rate ω_{z} of the vehicle and/or a current lateral velocity v_{y} of the vehicle; and
determine a steering angle δ_{f} for a front steered axle and a steering angle δᵣ for a rear steered axle to minimise a difference between the current yaw rate ω_{z} and the desired yaw rate ω_{z,req} and a difference between the current lateral velocity v_{y} and the desired lateral velocity v_{y,req}.

5. The computer system of claim 4, wherein the processing circuitry is configured to determine the steering angles δ_{f}, δᵣ using optimal control.

6. The computer system of claim 1, wherein the processing circuitry is configured to:
acquire a steering angle for a first steered axle of the vehicle; and
determine a steering angle for the other steered axle of the vehicle according to:
$${δ}_{r} = \frac{m}{{C}_{r α}} ( \frac{{v}_{y , req} {c}_{1}}{{v}_{x}} + {ω}_{z , req} ( {v}_{x} + \frac{{c}_{2}}{{v}_{x}} ) - {δ}_{f} \frac{{C}_{f α}}{m} ) \qquad ( a )$$
$$and / or$$
$${δ}_{r} = \frac{{I}_{z}}{{L}_{r} {C}_{r α}} ( - \frac{{v}_{y , req} {c}_{3}}{{v}_{x}} - {ω}_{z , req} \frac{{c}_{4}}{{v}_{x}} + {δ}_{f} \frac{{L}_{f} {C}_{f α}}{{I}_{z}} ) \qquad ( b )$$
where δ_{f} is the steering angle for the front steered axle δᵣ is the steering angle for the rear steered axle, m is the mass of the vehicle, vₓ is the longitudinal velocity of the vehicle, C_{fα} is the cornering stiffness of the front steered axle, C_{rα} is the cornering stiffness of the rear steered axle, L_{f} is the distance from the centre of gravity, CoG, of the vehicle to the front steered axle, Lᵣ is the distance from the CoG of the vehicle to the rear steered axle, I_{z} is the yaw inertia of the vehicle, and c₁ to C₄ represent vehicle constants.

7. The computer system of claim 6, wherein the processing circuitry is configured to determine a first steering angle for the other steered axle according to equation, determine a second steering angle for the other steered axle according to equation, and determine a resultant steering angle δᵣ for the other steered axle based on a weighted combination of the first steering angle and the second steering angle.

8. The computer system of claim 6, wherein the processing circuitry is configured to acquire the steering angle for the first steered axle of the vehicle from an autonomous driving system of the vehicle.

9. The computer system of claim 1, wherein the processing circuitry is configured to determine a steering angle δ_{f} for a front steered axle and a steering angle δᵣ for a rear steered axle, according to:
$${δ}_{r} = \frac{m}{{C}_{r α}} ( \frac{{v}_{y , req} {c}_{1}}{{v}_{x}} + {ω}_{z , req} ( {v}_{x} + \frac{{c}_{2}}{{v}_{x}} ) - {δ}_{f} \frac{{C}_{f α}}{m} )$$
$${δ}_{r} = \frac{{I}_{z}}{{L}_{r} {C}_{r α}} ( - \frac{{v}_{y , req} {c}_{3}}{{v}_{x}} - {ω}_{z , req} \frac{{c}_{4}}{{v}_{x}} + {δ}_{f} \frac{{L}_{f} {C}_{f α}}{{I}_{z}} )$$
where m is the mass of the vehicle, vₓ is the longitudinal velocity of the vehicle), C_{fα} is the cornering stiffness of the front steered axle, C_{rα} is the cornering stiffness of the rear steered axle, L_{f} is the distance from the centre of gravity “CoG” of the vehicle to the front steered axle, Lᵣ is the distance from the CoG of the vehicle to the rear steered axle, I_{z} is the yaw inertia of the vehicle, and c₁ to c₄ represent vehicle constants.

10. The computer system of claim 9, wherein the processing circuitry is configured to determine the steering angles δ_{f}, Sr offline using a feedforward controller.

11. The computer system of claim 1, wherein the processing circuitry is configured to transmit the determined steering angle to a controller of the vehicle configured to control the steering angle of the steered axle.

12. A vehicle comprising the computer system of claim 1.

13. A computer-implemented method for determining a steering angle for a steered axle of a vehicle having two steered axles, the computer-implemented method comprising:
acquiring, by processing circuitry of a computer system, a desired yaw angle of the vehicle at a second location;
determining, by the processing circuitry, a desired yaw rate ω_{z,req} for the vehicle based on the desired yaw angle and a time for the vehicle to travel from a first location to the second location;
acquiring, by the processing circuitry, a lateral distance between the first location and the second location;
determining, by the processing circuitry, a desired lateral velocity v_{y,req} for the vehicle based on the lateral distance and the time for the vehicle to travel from the first location to the second location; and
determining, by the processing circuitry, a steering angle for a steered axle of the vehicle using a bicycle model and based on the desired yaw rate ω_{z,req} and the desired lateral velocity v_{y,req}.

14. The computer-implemented method of claim 13, wherein the steered axle is a front steered axle or a rear steered axle of the vehicle.

15. The computer-implemented method of claim 13, comprising determining, by the processing circuitry, the desired yaw rate ω_{z,req} and/or the desired lateral velocity v_{y,req} based on steady state movement of the vehicle.

16. The computer-implemented method of claim 13, comprising: acquiring, by the processing circuitry, a current yaw rate ω_{z} of the vehicle and a current lateral velocity v_{y} of the vehicle; and determining, by the processing circuitry, a steering angle δ_{f} for a front steered axle and a steering angle δᵣ for a rear steered axle to minimise a difference between the current yaw rate ω_{z} and the desired yaw rate ω_{z,req} and a difference between the current lateral velocity v_{y} and the desired lateral velocity v_{y,req}.

17. The computer-implemented method of claim 16, comprising determining, by the processing circuitry, the steering angles δ_{f}, δᵣ using optimal control.

18. The computer-implemented method of claim 13, comprising transmitting the determined steering angle to a controller of the vehicle configured to control the steering angle of the steered axle.

19. A computer program product comprising program code for performing, when executed by processing circuitry, the computer-implemented method of claim 13.

20. A non-transitory computer-readable storage medium comprising instructions, which when executed by processing circuitry, cause the processing circuitry to perform the computer-implemented method of claim 13.
